(19) United States
(12) Patent Application Publication
(10) Pub. No.: US 2026/0187339 A1
(43) Pub. Date: Jul. 2, 2026

(54) ADAPTIVE TEXT RENDERING SYSTEM FOR DIGITAL CONTENT EDITING APPLICATIONS

(71) Applicant: Wix.com Ltd., Tel Aviv (IL)

(72) Inventor: Yehezkel Elad JACOB, Tel Aviv (IL)

(21) Appl. No.: 19/436,254

(22) Filed: Dec. 30, 2025

Related U.S. Application Data
(60) Provisional application No. 63/740,355, filed on Dec. 31, 2024.

(51) Int. Cl. G06F 40/106; G06F 40/191

(52) U.S. Cl. CPC G06F 40/106; G06F 40/191

(57) ABSTRACT

A system for adaptive text rendering includes an editor, a context analyzer, an adaptive text generator, and a feedback and learning engine. The editor renders a text box on a digital canvas and receives user input via the text box. The context analyzer extracts contextual information from digital content associated with the digital canvas. The adaptive text generator uses the user input, text box dimensions, and contextual information to direct an artificial intelligence (AI) model to generate text. It then formats the generated text to fit within the text box based on one or more fit criteria. The feedback and learning engine captures and evaluates user feedback related to the formatted text and generates tuning adjustments to refine the adaptive text generator or the AI model.

### CROSS REFERENCE TO RELATED APPLICATIONS

This application claims priority from U.S. provisional patent application 63/740,355 filed Dec. 31, 2024, which is incorporated herein by reference.

### FIELD OF THE INVENTION

The present invention relates generally to digital content editing systems and to adaptive text rendering within digital content editors in particular.

### BACKGROUND OF THE INVENTION

In digital content creation environments, such as web-based editing tools, desktop publishing applications, and mobile content platforms, users often work with text elements that are placed within designated spaces or containers on a page. These containers, commonly known as text boxes, are used to hold and display textual content.

In a typical website editor, a user can add a text box to a webpage and input text into it. The editor provides a graphical user interface with various tools that allow the user to format the text, including adjusting its font, size, and alignment. The figures illustrate such a content editing environment, where a user interacts with a text box on a webpage or digital canvas. A digital canvas refers to any digital, visual, and interactive workspace within a content editing or mobile application editing environment where a user can add, arrange, and manipulate digital content elements. The digital canvas serves as the primary layout surface upon which the text box is rendered and manipulated. The user can input text into the text box and manually adjust the dimensions of the box, for instance, by dragging its handles to change its width or height.

### SUMMARY OF THE PRESENT INVENTION

There is therefore provided, in accordance with a preferred embodiment of the present invention, a system for adaptive text rendering including at least one processor, and at least one memory storing instructions that, when executed by the at least one processor, configure the system to include an editor, a context analyzer, an adaptive text generator, and a feedback and learning engine. The editor is configured to render a text box having dimensions on a digital canvas, the digital canvas including associated back-end and front-end digital content, and to receive user input via the text box. The context analyzer is to extract contextual information from the associated digital content. The adaptive text generator is to receive the user input, the dimensions of the text box, and the contextual information from the context analyzer, to leverage an artificial intelligence (AI) model to generate text based on the user input and the contextual information, and to further format the generated text for rendering in the text box based on one or more fit criteria. The feedback and learning engine is to capture and evaluate user feedback related to the adapted text and to generate tuning adjustments to refine at least one of the adaptive text generator or AI model according to the user feedback.

Moreover, in accordance with a preferred embodiment of the present invention, the digital canvas is one of a webpage, a document page, a presentation slide, and a mobile application view.

Further, in accordance with a preferred embodiment of the present invention, the associated digital content further includes at least one of additional digital content from one or more digital canvases associated with a user account of the editor, and aggregated digital content from a plurality of user accounts associated with the editor.

Still further, in accordance with a preferred embodiment of the present invention, the fit criteria includes at least one of a target occupancy range for an area of the text box, a minimum font size, and a selection of an overflow behavior.

Additionally, in accordance with a preferred embodiment of the present invention, the overflow behavior is selected from at least one of truncation of the text, insertion of an ellipsis, and rendering of a scrollbar.

Moreover, in accordance with a preferred embodiment of the present invention, the context analyzer further includes a website analyzer and a metadata extractor. The website analyzer is to extract contextual information from visible content on the associated digital canvas, and the metadata extractor is to retrieve non-visible metadata associated with the associated digital canvas.

Further, in accordance with a preferred embodiment of the present invention, the adaptive text generator further includes a prompt engineering module, an AI service, and a text formatter. The prompt engineering module is to construct a prompt for the AI model based on the user input, the dimensions of the text box, and the contextual information, the AI service is to manage interaction with the AI model, and the text formatter is to determine rendering parameters for the generated text.

Still further, in accordance with a preferred embodiment of the present invention, the prompt engineering module further includes a dimensional analyzer, a content analyzer, and a prompt creator. The dimensional analyzer is configured to classify a size of the text box, the content analyzer is to infer a theme and style from the contextual information, and the prompt creator is configured to construct the prompt based on an output of the dimensional analyzer and the content analyzer.

Additionally, in accordance with a preferred embodiment of the present invention, the text formatter further includes a multi-modal measurer, a Cascading Style Sheets (CSS) property simulator, and a layout calculator. The multi-modal measurer is to determine font metrics, the Cascading Style Sheets (CSS) property simulator is to account for text-affecting properties, and the layout calculator is to determine final text properties based on an output of the multi-modal measurer and the CSS property simulator.

Moreover, in accordance with a preferred embodiment of the present invention, the feedback and learning engine further includes a feedback capturer and a model fine-tuner. The feedback capturer is configured to monitor implicit and explicit user interactions with the formatted text, and the model fine-tuner is configured to process the user interactions to generate the tuning adjustments.

There is therefore provided, in accordance with a preferred embodiment of the present invention, a computer-implemented method for adaptive text rendering. The method includes rendering a text box having dimensions on a digital canvas, the digital canvas having associated back-end and front-end digital content, receiving user input via the text box, extracting contextual information from the associated digital content, generating text using an artificial intelligence (AI) model, based on the user input, the dimensions of the text box, and the contextual information, formatting the generated text for rendering in the text box based on one or more fit criteria, capturing and evaluating user feedback related to the formatted text, and generating tuning adjustments to refine at least one of the generating or formatting steps based on the user feedback.

Moreover, in accordance with a preferred embodiment of the present invention, the digital canvas is one of a webpage, a document page, a presentation slide, and a mobile application view.

Further, in accordance with a preferred embodiment of the present invention, the extracting of contextual information further includes analyzing at least one of additional digital content from one or more digital canvases associated with a user account, and aggregated digital content from a plurality of user accounts.

Still further, in accordance with a preferred embodiment of the present invention, the formatting is based on one or more fit criteria including at least one of a target occupancy range for an area of the text box, a minimum font size, and a selection of an overflow behavior.

Additionally, in accordance with a preferred embodiment of the present invention, the selected overflow behavior includes at least one of truncating the text, inserting an ellipsis, and rendering a scrollbar.

Moreover, in accordance with a preferred embodiment of the present invention, the extracting of contextual information includes extracting contextual information from visible content on the digital canvas, and retrieving non-visible metadata associated with the digital canvas.

Further, in accordance with a preferred embodiment of the present invention, the generating and formatting of the text includes constructing a prompt for the AI model based on the user input, the dimensions of the text box, and the contextual information, managing interaction with the AI model to receive the generated text, and determining rendering parameters for the generated text.

Still further, in accordance with a preferred embodiment of the present invention, the constructing of the prompt further includes classifying a size of the text box, inferring a theme and style from the contextual information, and constructing the prompt based on the classified size, and the inferred theme and style.

Additionally, in accordance with a preferred embodiment of the present invention, the determining of rendering parameters includes determining font metrics, accounting for text-affecting properties using a Cascading Style Sheets (CSS) simulation and determining final text properties based on the determined font metrics and the CSS simulation.

Moreover, in accordance with a preferred embodiment of the present invention, the capturing and evaluating of user feedback and the generating of tuning adjustments includes monitoring implicit and explicit user interactions with the formatted text and processing the user interactions to generate the tuning adjustments.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic block diagram illustration of an adaptive text rendering system, constructed and operative in accordance with an embodiment of the present invention;

FIG. 2 is a block diagram illustration of the elements of an editor forming part of the system of FIG. 1, constructed and operative in accordance with an embodiment of the present invention;

FIG. 3 is a screenshot of a user interaction involving a content request within a text box, constructed and operative in accordance with an embodiment of the present invention;

FIG. 4 is a screenshot of a user interaction involving a resize request of the text box of FIG. 3, constructed and operative in accordance with an embodiment of the present invention;

FIG. 5 is a block diagram illustration of the sub-elements of the context analyzer of the system of FIG. 1, constructed and operative in accordance with an embodiment of the present invention;

FIG. 6 is a block diagram illustration of the sub-elements of the adaptive text generator of the system of FIG. 1, constructed and operative in accordance with an embodiment of the present invention;

FIG. 7 is a block diagram illustration of the sub-elements of the prompt engineering module of the system of FIG. 1, constructed and operative in accordance with an embodiment of the present invention;

FIG. 8 is a block diagram illustration of the sub-elements of the text formatter FIG. 6, constructed and operative in accordance with an embodiment of the present invention;

FIG. 9 is a screenshot of the rendered state of the text box of FIG. 3 after the system of FIG. 1 has completed its adaptation process, constructed and operative in accordance with an embodiment of the present invention;

FIG. 10 is a block diagram illustration of the sub-elements of the feedback and learning engine forming part of the system of FIG. 1, constructed and operative in accordance with an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, certain methods, procedures, and components have not been described in detail so as not to obscure the present invention.

Applicant has realized that in various text editing environments, including web-based tools, desktop applications, and mobile content creation platforms, users often face significant challenges when working with text elements that need to be fitted within designated spaces. Existing systems typically require users to perform manual adjustments to ensure proper text fitting, a process that can be time-consuming and prone to layout errors and repeated re-rendering, particularly when dealing with responsive designs or frequent content updates.

These challenges may manifest in two primary ways. First, there is the difficulty of generating appropriate and contextually relevant text content to fill a designated area without tedious manual composition. Second, there is the challenge of dynamically adapting the text content and its formatting when the dimensions of its container are modified, all without sacrificing readability or visual appeal. There remains a need for an automated system that can both generate suitable text and adapt it intelligently when container dimensions change.

Applicant has realized that a solution to overcoming these challenges is an adaptive text rendering system specifically configured for digital content editing environments. The system introduces an automated workflow that intelligently manages both text content and its presentation. In one aspect, the system utilizes a large language model (LLM) configured to receive user input and contextual information from the surrounding digital content. Based on this data and the specific dimensions of a target text container, the LLM generates new, adaptive text that is contextually appropriate and instructed to target a length (e.g., a word/character/token range) corresponding to the available space, the output being optionally iteratively revised and/or formatted to satisfy one or more fit criteria. As used herein, “fit criteria” may include one or more of: (i) no overflow beyond a boundary of a text box by more than a threshold, (ii) target occupancy of the text box area within a range, (iii) minimum font size and/or readability constraints, and/or (iv) selection of overflow behavior (e.g., truncation, ellipsis, scrolling). It will be appreciated that the term target occupancy refers to a predefined, desirable range for the proportion of the total available area of the text box that is filled by the rendered text. This criterion is established to ensure that the final text block appears visually balanced, avoiding both excessive, sparse white space and overly dense, cramped text. For example, a target occupancy range may be set to 85% to 95% of the total available area of the text box.

As used herein, “readability criteria” may include one or more objective constraints such as a minimum font size, a minimum line-height-to-font-size ratio, a maximum number of lines, a maximum average line length, and/or a limit on hyphenation frequency. As used herein, “layout-quality criteria” may include objective constraints such as avoiding single-word final lines, limiting orphan/widow lines, limiting variance in line lengths, and/or limiting truncation to a maximum fraction of the generated text.

To address the technical problems inherent in computer-based content rendering, the system provides a specific improvement to the functioning of the digital editor itself. Rather than merely applying generic rules, the system analyzes a plurality of dimensional and contextual factors to select a content generation approach based on one or more criteria. Concurrently, a text formatting module performs calculations and/or measurements, including simulation and/or test rendering of one or more rendering properties, to determine candidate font size, line spacing, and layout parameters based on one or more fit and readability criteria. This is configured to help ensure the text is not only generated to fit but is also rendered without clipping beyond a threshold and subject to one or more readability criteria, creating a more efficient and effective human-computer interaction within the editor.

Furthermore, the system is designed as a dynamic and self-improving technical tool. It incorporates a feedback and learning engine that captures and processes both implicit user interactions, such as resizing a container after generation, and explicit user ratings. This feedback is transformed into structured data used to adapt one or more of: prompt templates, prompt-parameter selection, candidate-ranking parameters, and/or strategy-selection logic; and, in some embodiments, to train or fine-tune one or more models (e.g., periodically, and/or offline based on aggregated feedback). This creates a virtuous cycle where the system's performance improves over time, adapting to user preferences and behaviors, enhancing the core functionality of the content editing platform.

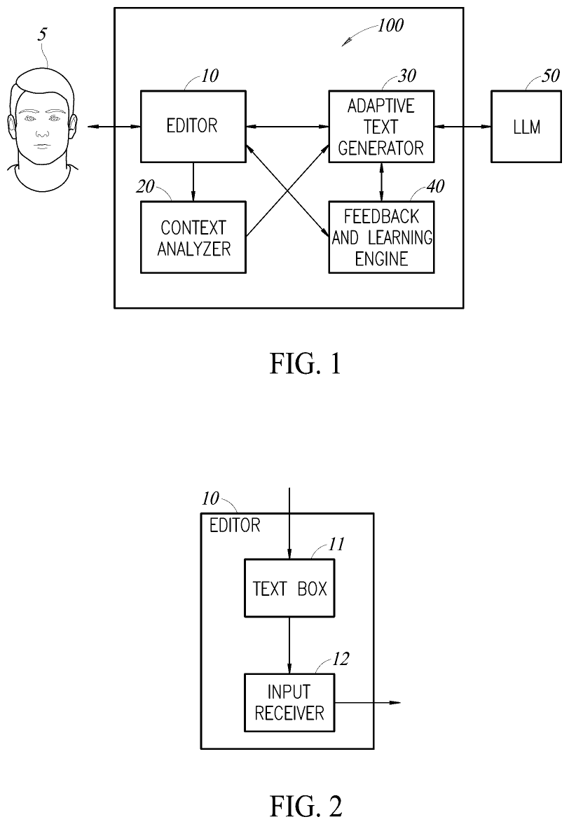

Reference is now made to FIG. 1 which illustrates an adaptive text rendering system 100, constructed and operative according to an embodiment of the present invention. System 100 may interact with a user and an external Large Language Model (LLM) 50 to generate and format text within a digital content editing environment.

It will be appreciated that while system 100 may be a standalone application, it may typically be implemented as an integrated feature or sub-system within a larger host application, such as a website building system (WBS). Its adaptive text rendering capabilities may be implemented in a wide range of digital content creation environments, including but not limited to desktop publishing applications, document processors, presentation software, mobile content creation apps, and other platforms where dynamic text fitting and generation are required.

System 100 may comprise an editor 10, a context analyzer 20, an adaptive text generator 30, and a feedback and learning engine 40.

The process may begin when a user interacts with editor 10, which serves as the primary user-facing interface. This interaction may involve inputting new text or resizing a visual text container on a webpage or digital canvas. Editor 10 may capture this user action and send relevant data to other parts of system 100. It will be appreciated that editor 10 may function in a similar manner to WBS editor 110 as described in U.S. Pat. No. 10,209,966 entitled “Custom Back-End Functionality in an Online Website Building Environment” granted Feb. 19, 2019, commonly owned by Applicant and incorporated herein by reference.

Context analyzer 20 may be responsible for gathering and processing contextual information from both back-end and front-end digital content surrounding text box 11. It will be appreciated that this may include data related to the entire website, document, or project of which the current digital canvas is a part of. As discussed herein above, the digital canvas is the interactive workspace within a content editing or mobile application editing environment and may be but not limited to: a webpage, a document page, a presentation slide, and a mobile application view. The digital content utilized by context analyzer 20 may extend beyond the immediate digital canvas (front-end input) and may include site-level information, such as content from other pages or canvases within the same project, global branding attributes like a company mission or defined brand voice, and integrated data from sources like product catalogs or external data feeds, all of which ensure thematic consistency. Furthermore, context analyzer 20 may leverage user-level content, including historical interaction data such as prior prompts and subsequent user edits, which enable personalization and adaptation to an individual's stylistic preferences. In some embodiments, the digital content may also comprise aggregated and anonymized data from a plurality of user accounts, allowing the system to infer industry-specific best practices, stylistic conventions, and effective content strategies.

Upon receiving the “state of the website” from editor 10, context analyzer 20 may analyze the webpage to extract relevant “contextual information”, which may include surrounding text, image descriptions, and metadata. This contextual information is then passed to adaptive text generator 30.

Adaptive text generator 30 may orchestrate the text generation and formatting process. It may receive the user input and/or container dimensions from editor 10 and contextual information from context analyzer 20. Using these inputs, it may formulate a precise prompt and send it to external LLM 50. LLM 50 may process this prompt to generate new text content in a raw text format, which is then returned to adaptive text generator 30 for processing and adaptation including formatting it to fit the specified container dimensions. Finally, it may send the final adapted text back to editor 10, where it is rendered for user 5.

Simultaneously, feedback and learning engine 40 may create a continuous improvement cycle. It may capture user 5 feedback on the generated text via editor 10, which can be implicit (e.g., user 5 immediately resizing or deleting the text) or explicit (e.g., user ratings). It may then process the feedback to generate tuning adjustments for adaptive text generator 30 and LLM 50, allowing system 100 to refine its performance and better meet user needs over time. This interaction establishes a closed-loop system where text generation is continuously informed by user behavior.

Editor 10 may be any web-based platform that allows user 5 to design, create and manage a website without requiring extensive coding knowledge or technical expertise. It may provide an intuitive drag and drop interface where users can add and edit their content for their websites. In addition, user 5 may set the layout of the website including dimensions of each element.

Reference is now made to FIG. 2 which illustrates the elements of editor 10. Editor 10 may further comprise a text box 11 and an input receiver 12.

Text box 11 is the specific visual container for text, rendered on the interface of editor 10. A key characteristic of text box 11 is that its dimensions, such as width and height, are user-manipulable. Text box 11 may serve a dual role, it is the element where user 5 initially inputs text, and it is also the destination where the final, adapted text generated by adaptive text generator 30 is rendered for user 5 to see. Therefore, its dimensions are an important input parameter for the system, directly influencing the formatting and content of the final output.

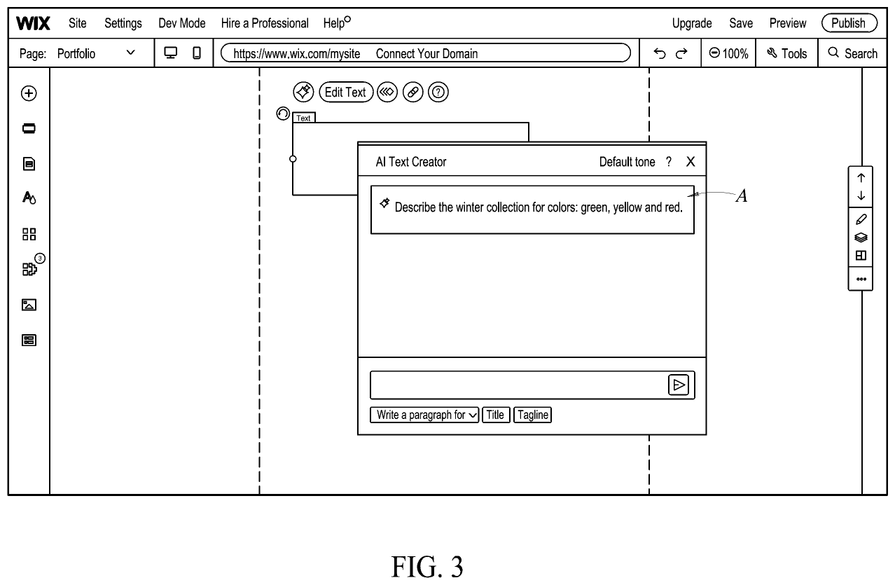

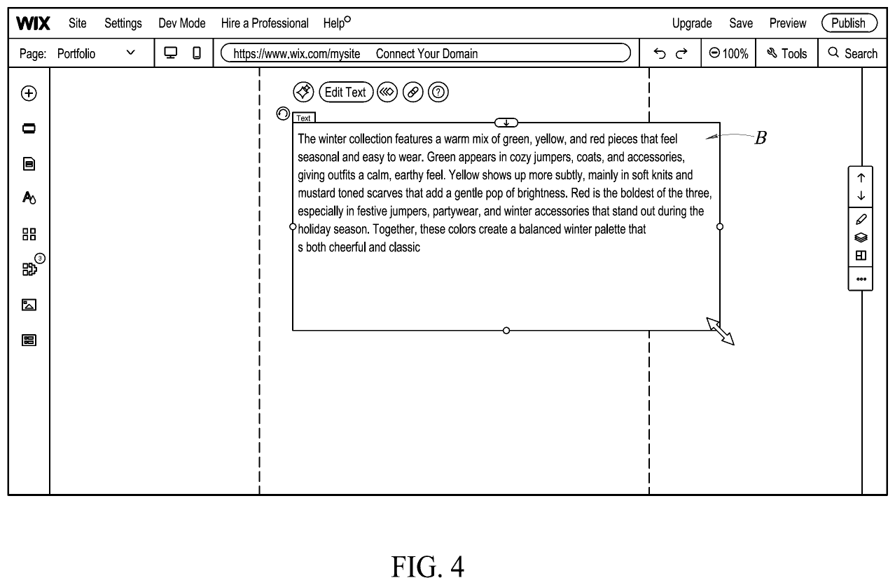

User 5 may begin by adding a text element within text box 11. Instead of typing out a full paragraph, user 5 may provide a brief instruction or topic as is illustrated in FIG. 3 to which reference is now made. As can be seen in FIG. 3, section A as marked, user 5 may ask (for example), “describe the winter collection for colors: green, yellow and red”. In another embodiment, user 5 may already have text to be displayed and may resize text box 11 instead. It will be appreciated that text box 11 may comprise handles for manual manipulation of text box 11 (marked B) as is illustrated in FIG. 4 to which reference is now made. It will be appreciated that a user may either request content or adjust the size of text box 11 or may perform both activities.

Input receiver 12 may detect and capture specific, predefined user actions that may serve as trigger events for system 100. Input receiver 12 may distinguish between content requests and resize requests. A content request is captured when user 5 inputs or edits text within text box 11, initiating the text creation functionality. A resize request is captured when user 5 manipulates the dimensions of text box 11, such as by dragging its corners or sides, which initiates the text adaptation functionality. In some embodiments, editor 10 may further provide a user-initiated regeneration control, such as a refresh or regenerate command, enabling user 5 to request regeneration of adapted text for the current dimensions of text box 11. In a further embodiment, adaptive text generator 30 may generate a plurality of candidate text variations, and editor 10 may present the plurality of candidates to user 5 for selection. User selections and subsequent edits may be captured as feedback for learning and tuning purposes. In this scenario input receiver 12 may also record any changes in text box 11's dimensions.

It will be appreciated that a resize request may also be generated automatically without direct user manipulation of text box 11. Such resize events may occur as a result of responsive layout recalculation, dynamic layout changes caused by modifications to other page elements, concurrent editing by another editor of the same digital content, updates to dynamic data fields including embedded external data placeholders, or changes in viewport size or rendering platform. In such cases, input receiver 12 may detect the resulting dimensional change and trigger the text adaptation functionality.

In another embodiment, editor 10 may be configured to optimize the triggering of the text adaptation process during rapid formatting edits. For instance, when user 5 applies multiple formatting options in quick succession (e.g., applying bold, then italic, then changing font color), editor may be designed to delay the initiation of the text adaptation functionality. Rather than triggering adaptive text generator 30 after each individual formatting change, editor 10 may wait for a predetermined pause in user 5's editing activity. Once user 5 has finished applying the series of formatting changes, editor 10 may then triggers a single adaptation process. This method serves to enhance system 100 performance by preventing multiple, resource-intensive regeneration cycles and improves the user experience by maintaining the layout integrity of the digital content without visual flickering or intermediate, unstable rendering states.

It will be appreciated that upon capturing one of these events, input receiver 12 may also provide the “state of the website”, i.e., a data representation of the current webpage containing text box 11, to context analyzer 20. The “state of the website” is not the user's direct input but rather a snapshot of the entire webpage environment where user action occurred. In some embodiments, the snapshot may comprise a filtered subset of the webpage model (e.g., elements within a proximity threshold of text box 11 plus selected global metadata) to reduce processing and token usage. It will be appreciated that editor 10 typically maintains a complete, up-to-the-moment data model of the page being edited. This model, often a structure like a JavaScript Object Notation (JSON) object or a document object model (DOM) tree, may contain all elements on the page, text, images, sections, etc., and their associated properties. When triggered, editor 10 may access this internal model and assemble a data package containing the relevant data needed for contextual analysis representing the “state of the website.”

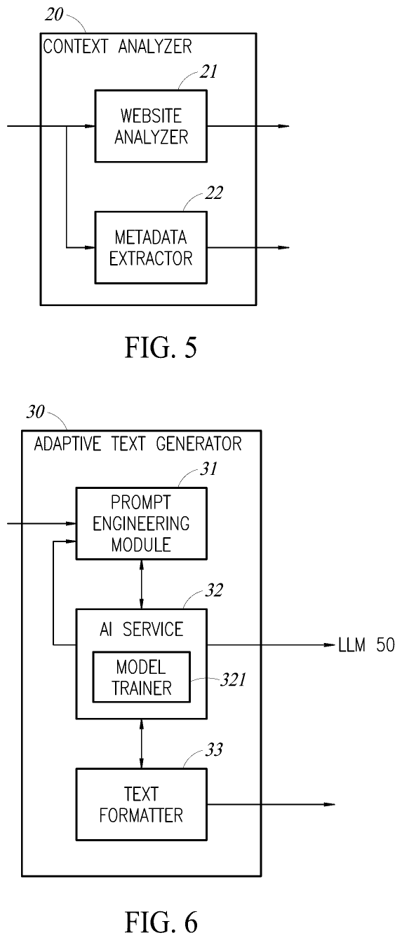

Context analyzer 20 may comprise a website analyzer 21 and a metadata extractor 22 as illustrated in FIG. 5 to which reference is now made. Upon receiving the “state of the website” data package from editor 10, website analyzer 21 and metadata extractor 22 may perform a comprehensive analysis to provide context information for adaptive text generator 30. In various embodiments, website analyzer 21 and metadata extractor 22 may function in parallel (as shown in FIG. 5) or sequentially.

Website analyzer 21 may extract contextual information from the visible content of the webpage. It may parse the page's structure and content to understand the immediate environment surrounding user 5's interaction. It may analyze and extract key visible elements, including the text from surrounding paragraphs and headers, as well as descriptive text associated with any nearby images, such as captions or alt-text. Website analyzer 21 may also process the main text of the entire webpage which also may include the full body of any articles, stories, product descriptions, or other significant content blocks present on the page. By processing this visible information, website analyzer 21 may provide a localized understanding of the topic, tone, and style of the specific section of the page user 5 is editing.

In some embodiments, the contextual information may not be limited to the current webpage. Website analyzer 21 may additionally retrieve context from other pages of the same website and, in some cases, from other websites associated with the same user account, where such information is available to system 100 and permitted by applicable access controls, privacy settings, and/or user authorization, and subject to all relevant laws, regulations, and user intellectual property and other rights. Such contextual information may include site-level metadata, global headings, branding attributes, or information provided during a site-creation process.

The contextual information may further include historical generation data associated with text box 11 or the current page, including previously generated prompts, prior LLM outputs, and prior user 5 edits or selections, to maintain stylistic and thematic consistency across multiple adaptation events.

Metadata extractor 22 may retrieve non-visible data associated with the webpage. This data, typically located in the page's header, provides a higher-level, thematic understanding of the page's overall purpose. Metadata extractor 22 may also retrieve crucial information such as the page title, search engine optimization (SEO) keywords, and meta tags, including the page's meta description. Meta tags may include tagline or keywords associated with the webpage such as “travel photography” or “adventure blog”. It may also include descriptive attributes of the images on the webpage such as image metadata (e.g., Exchangeable Image File Format (EXIF) fields, captions, tags, and/or user-provided attributes) such as camera settings, location, and time, when available.

It will be appreciated that by retrieving full context such as main content like articles and stories allows system 100 to understand the theme, subject matter, and narrative of the page. This may prevent LLM 50 from generating text that, while locally coherent, might be thematically out of place.

For example, if user 5 is editing text box 11 within a long travel story about a trip to Japan, the global context (the full story) is used to guide generation such that if user 5 asks to “expand on local cuisine,” system 100 may generate text about sushi and ramen, not pizza and pasta.

As discussed herein above, adaptive text generator 30 may orchestrate the generation and formatting of text by analyzing user input, contextual information, and text box 11 dimensions to produce a final, ready-to-render text package that is contextually relevant and configured to fit within the dimensions of its container according to one or more fit criteria. Adaptive text generator 30 may further comprise a prompt engineering module 31, an artificial intelligence (AI) service 32 and a text formatter 33 as is illustrated in FIG. 6 to which reference is now made.

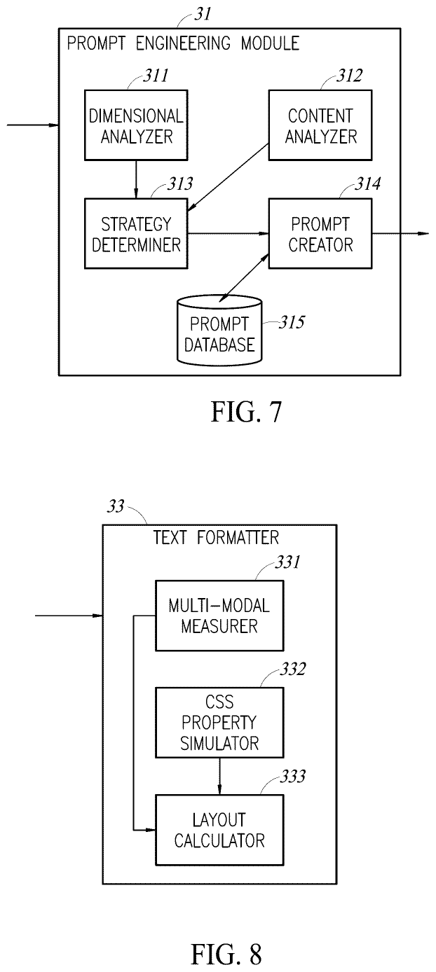

Prompt engineering module 31 may further comprise a dimensional analyzer 311, a content analyzer 312, a strategy determiner 313, a prompt creator 314 and a prompt database 315 as is illustrated in FIG. 7 to which reference is now made.

Prompt engineering module 31 may receive user 5 input, container/text box 11 dimensions, and contextual information and analyze these factors (as further described below) to select the most effective content generation strategy in order to formulate a precise, optimized prompt for LLM 50. The analysis may further consider characteristics of the user 5 input itself, including input text length, as an explicit signal when determining target content length and generation strategy.

The analysis performed by prompt engineering module 31 may encompass multiple dimensions of the input data to optimize the prompt construction process. In some embodiments, the analysis may evaluate the semantic complexity of user 5 input to determine whether the request requires simple text generation, complex multi-paragraph structuring, or specialized content formats such as lists, calls-to-action, or testimonial-style text.

The analysis may further assess the relationship between user 5 input and the extracted contextual information to identify potential conflicts or alignment opportunities. For example, if the user 5 input requests promotional content but the surrounding context indicates an informational or educational tone, the analysis may weight these factors to produce a prompt that balances user intent with contextual consistency.

In some embodiments, the analysis may evaluate temporal or seasonal relevance based on metadata or contextual cues, enabling the prompt engineering module to incorporate time-sensitive language or avoid outdated references. The analysis may also consider the target audience inferred from the digital content, such as professional, casual, technical, or consumer-oriented audiences and adjust prompt parameters accordingly.

The analysis may further include an assessment of content density requirements based on the interplay between container dimensions and content type. For instance, a narrow but tall container may favor vertically-oriented content structures, such as bullet points or short sentences, while a wide but short container may favor horizontally-flowing prose with longer sentences.

In some cases, the analysis may also evaluate the presence of existing text within or adjacent to the text box to determine whether the generation task involves creating new content, expanding existing content, or replacing content while maintaining continuity with surrounding elements. The analysis may further consider formatting constraints inherited from the digital canvas, such as predefined style sheets, brand guidelines, or template restrictions that may influence the structure and vocabulary of the generated text.

Finally, the analysis may incorporate historical performance data associated with similar input patterns, container configurations, or contextual profiles to inform strategy selection. This may include analyzing which prompt structures, length targets, or style directives have historically resulted in higher user acceptance rates for comparable generation scenarios.

Dimensional analyzer 311 may classify the container (text box 11) size into categories e.g., micro (<100 characters), small (100-300 characters), medium (300-800 characters), large (800-2000 characters), and extended (>2000 characters). It will be appreciated that the character ranges are exemplary and may be estimated based on font metrics, text style (including for example character/word/line spacing requirements), and/or pixel dimensions of text box 11; in some embodiments, the size classification is based on a target word count, token count, number-of-lines estimate, or area-based measure. Each size class may have an associated content strategy. For example, a “micro” container might trigger a “concise enhancement” strategy (adding brief adjectives), while a “medium” container might use a “paragraph development” strategy (adding supporting sentences). A “large” container may implement multi-paragraph structuring creating topic sentences, supporting details.

Content analyzer 312 may synthesize the information from context analyzer 20 to infer the webpage's theme, tone, and style. It may examine the entered user 5 input to determine content type (descriptive, instructional, promotional, narrative) and apply appropriate expansion strategies. It may further employ a context relevance scorer to evaluate the surrounding page content to help ensure that generated text maintains thematic consistency. It will be appreciated that content analyzer 312 may comprise its own internal pre-trained internal AI models to determine strategies.

Strategy determiner 313 may use the output from dimensional analyzer 311 and content analyzer 312 to determine instructions for prompt creator 314. It may use a multi-factor scoring algorithm that weighs factors including container size change magnitude, content type compatibility, contextual relevance scores, and historical preferences. Each resulting potential strategy may receive a weighted score, and the highest-scoring approach is selected.

It will be appreciated that the algorithms and AI models used by the sub elements of prompt engineering module 31 may be updated (e.g., periodically and/or based on accumulated feedback), including based on feedback generated by feedback and learning engine 40 as described in more detail herein below.

Based on the analysis of strategy determiner 313, prompt creator 314 may construct a detailed prompt. The prompt may include specific fields such as [USER_INPUT], a [CONTEXT_SUMMARY], a [CALCULATED_LENGTH] (target character count), and an [INFERRED_STYLE]. In some embodiments, [CALCULATED_LENGTH] may specify a length range and/or a maximum length and is used as a guidance constraint; if candidate outputs do not satisfy fit criteria, system 100 may iteratively adjust the length constraint and regenerate one or more candidates. In some embodiments, length constraints are expressed in words and/or tokens instead of characters or are converted between such measures. It will be appreciated that the prompt is not merely user 5's raw input but a detailed command containing placeholders for user 5 input, a context summary, a calculated target length, and an inferred style.

In one example, a prompt template may include a system directive and a user directive. The user directive may include the fields: “Instruction: {USER_INPUT}”, “Context: {CONTEXT_SUMMARY}”, “Target length: {MIN_WORDS}-{MAX_WORDS} words”, and “Style: {INFERRED_STYLE}”. The prompt template may further include an explicit constraint to avoid introducing facts not present in the context summary.

Prompt database 315 may store pre-defined templates for use depending on the prompt parameters required. It will be appreciated that choice of the correct template may be deterministic or may be aided by a pre-trained AI model. Accordingly, prompt creator 314 r may retrieve a suitable request template for the target LLM 50, populate the fields correspondingly, and transmit the final, optimized prompt to AI service 32.

AI service 32 may act as the intermediary between the internal logic of system 100 and external Large Language Model (LLM) 50. Its primary role is to manage the entire life cycle of the generative AI interaction, from sending a precisely engineered prompt to receiving the raw output and participating in the system 100's continuous learning loop as described in more detail herein below. AI service 32 may receive a fully-formed, structured prompt from prompt creator 314 and send it to LLM 50.

It will be appreciated that AI service 32 may employ a multi candidate generation approach creating multiple alternative text versions with different approaches (i.e. one focused on brevity, one on detail and one on emotional appeal etc.). For each option output, text formatter 33 may evaluate each candidate scoring them on fit quality, readability metrics, and layout-quality criteria (e.g., hyphenation count, widow/orphan avoidance, or line-length variance) as described in more detail herein below. AI service 32 may receive the fit quality score and utilize a candidate ranking algorithm to determine which output to use. If none of the candidate outputs satisfies the fit criteria, AI service 32 may request additional candidates, modify one or more prompt constraints (e.g., [CALCULATED_LENGTH], style directives), re-query LLM 50, and/or invoke a rewriting operation (e.g., summarization or expansion). In some embodiments, if fit criteria remain unsatisfied, system 100 may apply overflow behavior (e.g., truncation, ellipses, or scrollbars) and/or other changes such as spacing, font size etc. as described herein. It will be appreciated that AI service 32 may comprise a model trainer 321 which may refine both the strategic decision-making of AI service 32 and the core generative capabilities of the LLM 50.

As discussed in more detail herein below, feedback and learning engine 40 may provide data to fine-tune LLM 50 over time based on an analysis of implicit and explicit user feedback. In this scenario, model trainer 321 may update one or more model parameters and/or select among fine-tuned model variants of LLM 50. Such updates may be performed in batch and/or offline based on aggregated feedback data. This may improve the likelihood that LLM 50 becomes more adept at matching the desired [INFERRED_STYLE] (e.g., professional, casual, technical) with less explicit instruction and may improve its ability to generate text that is thematically consistent with the provided content.

LLM 50 may be any type of AI model specifically designed for natural language processing tasks, such as text generation, language translation, and text summarization. LLM 50 may be an open-weight model such as a Llama-family model available from Meta under license, or a proprietary LLM service available from a third party (e.g., OpenAI). It may be trained on vast amounts of text data to learn patterns, relationships, and context-specific knowledge that enables it to generate coherent and meaningful content.

Once a suitable raw text candidate has been generated, selected, or refined, AI service 32 may pass this unformatted text to text formatter 33.

Text formatter 33 may take the raw, unformatted text string received from AI service 32 and determine the formatting parameters required to render the text within the specified dimensions of text box 11 according to one or more fit criteria and/or overflow rules (e.g., truncation/ellipsis/scrollbars). It may take the actual generated text from LLM 50 and analyze it against the known dimensions of text box 11 to calculate final text properties or formatting parameters (font size, line height, wrapping rules, etc.) based on one or more fit and readability criteria, which may be used to make the specific text fit for rendering by editor 10.

Text formatter 33 may comprise a multi-modal measurer 331, a CSS (Cascading Style Sheets) property simulator 332 and a layout calculator 333 as is illustrated in FIG. 8 to which reference is now made.

Multi-modal measurer 331 may utilize a pre-calculated font metrics database that stores detailed information such as character width tables, baseline measurements, and kerning information for standard web fonts. For each font family, the database may maintain detailed metrics including x-height, cap-height, ascender and descender measurements, and average character widths across different weights and styles. For unknown or custom fonts, multi-modal measurer 331 may consult with a dynamic measurement module to calculate precise dimensions. This may create an off-screen rendering context, allowing it to use canvas-based text measurement application programming interfaces (APIs) to calculate the precise dimensions of any font in real-time.

CSS property simulator 332 may account for the full spectrum of text-affecting CSS properties. It may include a property impact calculator that quantifies how each property affects text dimensions (such as thin, light, medium, black). It may further employ a “weight-to-width mapping table” to handle font-weight variations, storing the relative width changes for different weights (e.g., how bold text increases width by a font-dependent amount (e.g., empirically determined per font family/weight, and/or measured dynamically)) and for uppercase, lowercase, and capitalize transformations before measurement, since these can significantly alter dimensions. Finally, it may handle complex line-wrapping scenarios, including hyphenation and overflow-wrap properties.

In addition, CSS property simulator 332 and layout calculator 333 may determine and apply alternative overflow and wrapping modes, including truncation of text to a target length, insertion of ellipses to indicate truncated content, and configuring overflow behavior to render a scrollbar when appropriate. The simulation may further account for text alignment properties, including left-aligned, center-aligned, and right-aligned text, and their impact on layout and fit.

Layout calculator 333 may use the raw string output of LLM 50 and the dimensions of text box 11 together with the output of multi-modal measurer 331 and CSS property simulator 332 to generate the final, definitive rendering instructions for how the text should be displayed. It is configured to help ensure that the final output is not only subject to one or more layout-quality criteria and readability criteria but also fits within its container or text box 11 (e.g., within a tolerance and/or subject to overflow behavior) without overflowing or appearing cramped.

As discussed herein above, layout calculator 333 may work in conjunction with AI service 32 to rank its output using a candidate ranking algorithm which may choose the best result from various layout techniques such as font-size adjustment, line-height adjustment, letter/word spacing adjustment, hyphenation and wrapping rules, and/or overflow behavior (e.g., truncation/ellipsis/scrollbars) i.e., it may determine how well specific text fits into a specific sized text box. Layout calculator 333 may implement layout adjustment techniques using mechanisms such as CSS Grid and Flexbox, or a box-sizing property.

Layout calculator 333 may execute an iterative fitting algorithm designed to solve the complex puzzle of fitting the text while maximizing readability. This process typically begins by simulating the layout with a target or maximum potential font size. Using the detailed character widths and simulated CSS adjustments, it may calculate the resulting dimensions of text box 11 and compare them against the container's actual boundaries. If the text overflows, it may reduce the font size and/or adjust the line height and re-runs the simulation, looping through this trial-and-error process until it identifies the largest possible font size at which the entire text block fits within the container according to the fit criteria. Layout calculator 333 may then determine and output the definitive set of final formatting parameters (such as final font size, line height, wrapping rules) which will be applied to the text.

It will be further appreciated that to help provide a seamless user experience, text formatter 33 is designed for high performance. It may utilize a caching mechanism that pre-calculates and stores formatting parameters for common container size ranges. This may reduce latency and, in some implementations and operating conditions, may achieve sub-100 ms response times for many text reformatting tasks, providing low-latency adaptation to user 5.

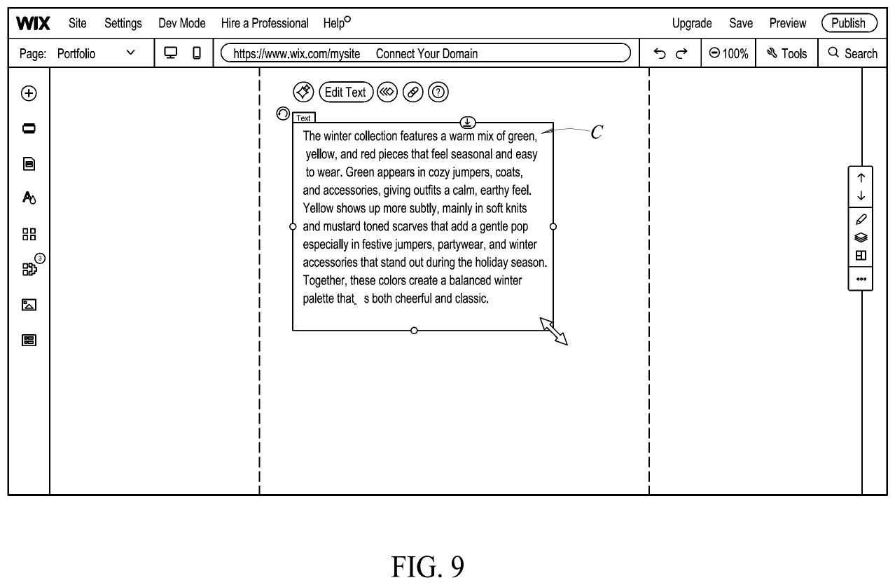

Reference is now made to FIG. 9 which illustrates the rendered state of text box 11 (section C) after user 5 has received adapted text for its query (FIG. 3) and has performed a resize action (FIG. 4). As is illustrated, text has been generated in response to user 5 input and it is sized to fit its container.

An example implementation by system 100 may be end-to-end generation and fit evaluation. In this scenario, editor 10 may receive, via text box 11, an instruction string indicating a topic and optional constraints. Editor 10 may provide system 100 with (i) dimensions of text box 11, (ii) a font-family identifier and initial font attributes, and (iii) a page state describing content elements within a proximity threshold of text box 11. Context analyzer 20 may then extract, from the page state, surrounding headings, paragraph text, and image-associated text (including alt-text and captions), and produces a context summary that is bounded to a maximum size.

Dimensional analyzer 311 may then determine a target length range as a function of the dimensions of text box 11 and font metrics. For example, dimensional analyzer 311 may estimate a candidate number-of-lines capacity based on height and an initial line height, may estimate an average characters-per-line capacity based on width and average glyph width for the font, and may convert the capacity to a target word range. Prompt creator 314 may generate a prompt accordingly including: (i) the instruction string, (ii) the context summary, (iii) the target length range, and (iv) style directives inferred from the page state.

AI service 32 may then request a plurality of candidate outputs from LLM 50. For each candidate output, text formatter 33 may simulate rendering using font metrics and layout rules to determine line breaks and a rendered text bounding region, and compute a fit score based on overflow amount and an occupancy ratio. It will be appreciated that the occupancy ratio is the calculated metric used to determine whether the target occupancy range is met. It is computed during text formatting simulation and is defined as the ratio of the area occupied by the rendered text to the total available area of text box 11. A fit score may be computed based on how closely the calculated occupancy ratio aligns with the predefined target occupancy range. If no candidate output satisfies the fit criteria, AI service 32 may adjust at least one generation constraint (including the target length range) and request additional candidates and/or invoke a rewriting operation. Upon selection of a candidate output, layout calculator 333 may determine rendering parameters for display, including at least font size and line height, and then may output the adapted text and rendering parameters to editor 10 for rendering in text box 11.

In a second example implementation (resize-triggered adaptation), after adapted text is rendered in text box 11, input receiver 12 may detect a resize event indicating a change in width, height, or both. System 100 may then re-evaluate fit criteria under the updated dimensions by simulating rendering of the existing text at the current rendering parameters. If overflow is detected beyond a threshold, system 100 may apply one or more actions, including (i) reducing font size subject to readability criteria, (ii) requesting a rewritten candidate output having a shorter target length range, and/or (iii) applying an overflow behavior including truncation with an ellipsis. If the resize event increases available area, system 100 may request a rewritten candidate output having a longer target length range and/or may increase font size subject to readability criteria.

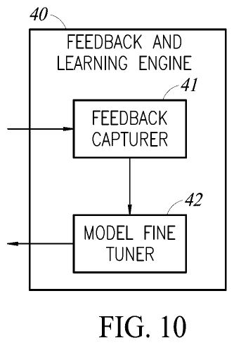

Feedback and learning engine 40 may enable system 100 to improve and adapt over time, creating a continuous improvement cycle. Its primary function is to capture user feedback on the generated text and use that feedback to refine the performance of adaptive text generator 30. The feedback is used to improve both the system 100's own internal logic (how it creates prompts) and LLM 50 itself (how it creates output). This is configured to help ensure that system 100 becomes progressively more aligned with user preferences and behaviors. Reference is now made to FIG. 10 which illustrates the sub elements of feedback and learning engine 40. Feedback and learning engine 40 may further comprise a feedback capturer 41 and a model fine-tuner 42.

Feedback capturer 41 is responsible for monitoring and collecting all user interactions with the text rendered in text box 11. It may gather raw data on user satisfaction through two distinct channels.

Feedback capturer 41 may use implicit feedback capture by monitoring user behavior to infer satisfaction levels without requiring direct input. It may continuously track user actions that serve as implicit signals. These actions may include the immediate deletion or significant modification of the generated text (a strong negative signal), immediate acceptance with no changes (a positive signal), or subsequent resizing of the container after text generation. These patterns provide valuable, unsolicited data on the quality and fit of the generated content.

Feedback capturer 41 may use explicit feedback by capturing direct feedback from user 5 through contextual interfaces that appear at appropriate moments. Explicit feedback may further include free-text feedback provided by user 5, such as qualitative or high-level guidance regarding tone, vocabulary level, or style. Such free-text feedback may be analyzed using natural language processing techniques and/or a large language model to extract structured directives, which may be incorporated into subsequent prompt construction and content generation. This allows users to explicitly communicate their preferences by, for example, giving a thumbs-up/thumbs-down rating, selecting from predefined options to specify desired changes, or providing written feedback on the quality of the adaptive text.

All of this raw feedback data, both implicit and explicit, is then passed to model fine-tuner 42 for processing.

Model fine-tuner 42 may process the raw feedback collected by feedback capturer 41 and convert it into actionable intelligence for use by adaptive text generator 30. It may transform user interactions into structured training examples by capturing crucial information such as the “before” and “after” states of the text, the specific modifications the user made, and the contextual factors present during the generation.

It will be appreciated that the output of model fine-tuner 42 is a set of tuning adjustments. These adjustments are then fed back into system 100 to refine the performance of its generative components. Specifically, these tuning adjustments are provided to model trainer 321. This allows system 100 to make immediate parameter adjustments for the current session, model medium-term user preferences, and contribute to long-term, system-wide improvements through model fine-tuning. By updating the strategy selection algorithms of AI service 32 and the parameters of the LLM 50's fine-tuning processes, model fine-tuner 42 is configured to learn from user 5 interactions (e.g., based on aggregated implicit/explicit feedback), subject to available feedback data and update policies, becoming progressively smarter and more effective over time.

Although the embodiments described above primarily relate to operation during content editing, in some embodiments system 100 may operate during runtime display of published digital content. During runtime, dimensions of text box 11 may change due to live publishing, editing by end users, responsive layout changes across devices or screen sizes, or updates to dynamic fields reflecting externally generated data. In response to such changes, system 100 may adapt text as described herein.

In embodiments where adapted text may be deployed without human review, system 100 may reduce the likelihood of inaccurate or hallucinated output by selecting AI models or model parameters configured to reduce hallucinations (e.g., by using retrieval-grounded prompts, lower-variance decoding parameters, and/or factuality checks against extracted context) and/or by applying a follow-on validation or gating mechanism that blocks, flags, or regenerates text that fails validation criteria.

Therefore system 100 provides a computer-implemented system for adaptive text rendering within a digital content editor. It combines two primary functionalities: intelligent content creation and dynamic text adaptation. Upon receiving user input, the system utilizes a context analyzer to extract thematic information from the surrounding webpage including text, images, and metadata and leverages a large language model (LLM) to generate a complete, contextually relevant block of text. Conversely, when a user manually resizes the text box, the system automatically triggers a text formatter to determine font size and line spacing based on one or more fit and readability criteria, and/or re-engages the LLM to intelligently shorten or lengthen the content to satisfy the fit criteria within the new dimensions. Crucially, a feedback and learning engine operates in a continuous loop, capturing both implicit and explicit user interactions to adapt (and in some embodiments fine-tune) the AI's prompting strategies and the LLM's generative capabilities.

Unless specifically stated otherwise, as apparent from the preceding discussions, it is appreciated that, throughout the specification, discussions utilizing terms such as “analyzing,” “generating,” “processing,” “computing,” “calculating,” “determining,” or the like, refer to the action and/or processes of a general purpose computer of any type, such as a client/server system, mobile computing devices, smart appliances, cloud computing units or similar electronic computing devices that manipulate and/or transform data within the computing system's registers and/or memories into other data within the computing system's memories, registers or other such information storage, transmission or display devices.

The inventive elements discussed hereinabove may be implemented on a suitable apparatus. This apparatus may be specially constructed for the desired purposes, or it may comprise a computing device or system typically having at least one processor and at least one memory, selectively activated or reconfigured by a computer program, code or prompt. The resultant apparatus when instructed by program, code or prompt may turn the general purpose computer into inventive elements as discussed herein. The program, code or prompt may define the inventive device in operation with the computer platform for which it is desired. Such program, code or prompt may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing programs, code or prompts. The computer readable storage medium may also be implemented in cloud storage.

In the disclosed computer-implemented methods, artificial intelligence functionality is implemented as one or more computational models executed by the computing system to perform technical data processing operations, including generating outputs based on received input data.

The AI functionality used in the computer-implemented methods as described herein above may be realized using one or more computational techniques, including rule-based logic, statistical models, machine learning models, neural networks, deep learning models, ensemble models, or combinations thereof.

The specific model architecture is not limiting, provided that the model is configured to perform the method steps described herein.

In some embodiments, the computer-implemented methods further include training one or more AI models using training data. Training may be performed as a separate computer-implemented method or as part of the same method, and may occur prior to deployment, during execution, or periodically during operation of the computing system.

During execution of the computer-implemented method, the computing system applies the trained AI model to input data to generate one or more outputs, which are then used by the computing system to perform subsequent method steps.

The computer-implemented methods include receiving input data, processing the input data using the AI model, and generating output data, wherein the output data represents a technical transformation of the input data and is stored, transmitted, displayed, or used by the computing system to control further operations.

Execution of the computer-implemented methods may produce non-deterministic outputs due to probabilistic processing performed by the AI model. Such variability is an inherent characteristic of the implemented computational techniques and does not affect execution of the method steps.

The computer-implemented methods may be executed on one or more computing devices, including servers, cloud computing environments, edge devices, or user devices. Execution may be centralized or distributed across multiple processors and memory resources.

The disclosed embodiments further include a non-transitory computer-readable medium storing instructions that, when executed by one or more processors, cause the processors to perform the computer-implemented methods described herein.

The description of computer-implemented methods and AI functionality is intended to be illustrative and not limiting. Variations and modifications that perform substantially the same functions in substantially the same manner are intended to fall within the scope of the appended claims.

Some general purpose computers may comprise at least one communication element to enable communication with a data network and/or a mobile communications network.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A system for adaptive text rendering, said system comprising:
at least one processor; and at least one memory storing instructions that, when executed by said at least one processor, configure the system to include:
an editor configured to render a text box having dimensions on a digital canvas, said digital canvas comprising associated back-end and front-end digital content; and to receive user input via said text box;
a context analyzer to extract contextual information from said associated digital content;
an adaptive text generator to receive said user input, said dimensions of said text box, and said contextual information from said context analyzer and to leverage an artificial intelligence (AI) model to generate text based on said user input and said contextual information;
said adaptive text generator to further format said generated text for rendering in said text box based on one or more fit criteria; and
a feedback and learning engine to capture and evaluate user feedback related to said adapted text and to generate tuning adjustments to refine at least one of said adaptive text generator or AI model according to said user feedback.

2. The system of claim 1, wherein said digital canvas one of a: webpage, a document page, a presentation slide, and a mobile application view.

3. The system of claim 1, wherein said associated digital content further includes at least one of: additional digital content from one or more digital canvases associated with a user account of said editor; and aggregated digital content from a plurality of user accounts associated with said editor.

4. The system of claim 1, wherein said fit criteria comprises at least one of: a target occupancy range for an area of said text box, a minimum font size, and a selection of an overflow behavior.

5. The system of claim 4, wherein said overflow behavior is selected from at least one of:
truncation of said text, insertion of an ellipsis, and rendering of a scrollbar.

6. The system of claim 1, wherein said context analyzer further comprises:
a website analyzer to extract contextual information from visible content on said associated digital canvas; and
a metadata extractor to retrieve non-visible metadata associated with said associated digital canvas.

7. The system of claim 1, wherein said adaptive text generator further comprises:
a prompt engineering module to construct a prompt for said AI model based on said user input, said dimensions of said text box, and said contextual information;
an AI service to manage interaction with said AI model; and
a text formatter to determine rendering parameters for said generated text.

8. The system of claim 7, wherein said prompt engineering module further comprises:
a dimensional analyzer configured to classify a size of said text box;
a content analyzer to infer a theme and style from said contextual information; and
a prompt creator configured to construct said prompt based on an output of said dimensional analyzer and said content analyzer.

9. The system of claim 7, wherein said text formatter further comprises:
a multi-modal measurer to determine font metrics;
a Cascading Style Sheets (CSS) property simulator to account for text-affecting properties; and
a layout calculator to determine final text properties based on an output of said multi-modal measurer and said CSS property simulator.

10. The system of claim 1, wherein said feedback and learning engine further comprises:
a feedback capturer configured to monitor implicit and explicit user interactions with said formatted text; and
a model fine-tuner configured to process said user interactions to generate said tuning adjustments.

11. A computer-implemented method for adaptive text rendering, said method comprising:
rendering a text box having dimensions on a digital canvas, said digital canvas comprising associated back-end and front-end digital content;
receiving user input via said text box;
extracting contextual information from said associated digital content;
generating text using an artificial intelligence (AI) model, based on said user input, said dimensions of said text box, and said contextual information;
formatting said generated text for rendering in said text box based on one or more fit criteria;
capturing and evaluating user feedback related to said formatted text; and
generating tuning adjustments to refine at least one of said generating or formatting steps based on said user feedback.

12. The method according to claim 11, wherein said digital canvas is one of a: webpage, a document page, a presentation slide, and a mobile application view.

13. The method according to claim 11, wherein said extracting of contextual information further comprises analyzing at least one of: additional digital content from one or more digital canvases associated with a user account; and aggregated digital content from a plurality of user accounts.

14. The method according to claim 11, wherein said formatting is based on one or more fit criteria comprising at least one of: a target occupancy range for an area of said text box, a minimum font size, and a selection of an overflow behavior.

15. The method according to claim 14, wherein said selected overflow behavior comprises at least one of: truncating said text, inserting an ellipsis, and rendering a scrollbar.

16. The method according to claim 11, wherein said extracting of contextual information comprises:
extracting contextual information from visible content on said digital canvas;
and retrieving non-visible metadata associated with said digital canvas.

17. The method according to claim 11, wherein said generating and formatting of said text comprises:
constructing a prompt for said AI model based on said user input, said dimensions of said text box, and said contextual information; managing interaction with said AI model to receive said generated text; and
determining rendering parameters for said generated text.

18. The method according to claim 17, wherein said constructing of said prompt further comprises: classifying a size of said text box; inferring a theme and style from said contextual information; and constructing said prompt based on said classified size, and said inferred theme and style.

19. The method according to claim 17, wherein said determining of rendering parameters comprises: determining font metrics; accounting for text-affecting properties using a Cascading Style Sheets (CSS) simulation; and determining final text properties based on said determined font metrics and said CSS simulation.

20. The method according to claim 11, wherein said capturing and evaluating of user feedback and said generating of tuning adjustments comprises: monitoring implicit and explicit user interactions with said formatted text; and processing said user interactions to generate said tuning adjustments.
